(19) United States
(12) Patent Application Publication
(10) Pub. No.: US 2024/0307958 A1
(43) Pub. Date: Sep. 19, 2024

(54) FRICTION MEMBER AND METHOD FOR MANUFACTURING SAME

(71) Applicant: CANON KABUSHIKI KAISHA, Tokyo (JP)

(72) Inventor: SHINGO EGUCHI, Kanagawa (JP)

(21) Appl. No.: 18/603,012

(22) Filed: Mar. 12, 2024

(30) Foreign Application Priority Data
Mar. 15, 2023 (JP) 2023-040820
Jan. 9, 2024 (JP) 2024-001515

(51) Int. Cl. B22F 5/00; B22F 3/12; B22F 3/24; B22F 3/26; C09K 3/14; G03B 13/36; H02N 2/00; H04N 23/68

(52) U.S. Cl. CPC B22F 5/00; B22F 3/12; B22F 3/26; C09K 3/149; G03B 13/36; H02N 2/0005; B22F 2003/248; B22F 2202/03; B22F 2301/35; B22F 2302/40; B22F 2998/10; B22F 2999/00; F16D 2200/0021; H04N 23/687

(57) ABSTRACT

A friction member includes a stainless-steel-based sintered body having a pore, and a resin material that is present in at least one portion of an inside of the pore, wherein the resin material is a silicone-based resin material, and has a maximum absorption peak intensity ratio Ia/Ib of 0.10 or more in a spectrum acquired based on an infrared spectroscopic analysis, where Ia is a maximum absorption peak intensity caused by stretching vibration of Si—H bond in a range of 2079 cm⁻¹ to 2415 cm⁻¹, and Ib is a maximum absorption peak intensity caused by stretching vibration of Si—O—Si bond in a range of 1000 cm⁻¹ to 1070 cm⁻¹.

### BACKGROUND

### Field of the Disclosure

The present disclosure relates to a friction member and a method for manufacturing the same.

### Description of the Related Art

Vibration-type actuators that relatively move a contact body and a vibration body including an electro-mechanical energy conversion element are known. The vibration-type actuator causes the vibration body and the contact body to be pressed against each other, and predetermined vibration is excited in the vibration body to provide a friction driving force from the vibration body to the contact body. Thus, the vibration body and the contact body are relatively moved. The vibration body includes a piezoelectric body and an elastic body that is bonded to the piezoelectric body. Application of a voltage to the piezoelectric body causes vibration that is generated in the piezoelectric body to be transmitted to the contact body via the elastic body.

As mentioned, the driving force of the vibration-type actuator depends on a friction force between the elastic body and the contact body. The contact body is expected to have a function of generating a friction force as a friction member. However, there is an issue. If the contact body is left under high-humidity environment, a friction force decreases. It is conceivable that water adsorbed onto the contact body under the high humidity environment is present as a water film on a surface of the contact body, and such a water film acts as a lubricating layer, causing a decrease in the friction force.

In a case where abrasion progresses due to sliding of the elastic body and the contact body, “adaptation” progresses. The term “adaptation” used herein represents a situation in which a distance in the periphery of a real contact portion between the elastic body and the contact body on a friction surface is shortened. In the resultant periphery of the real contact portion, a water film can act as a lubrication layer more easily, and a decrease in the friction force becomes more apparent.

To deal with such an issue, Japanese Patent Application Laid-Open No. 2022-155688 discusses a friction member made of a stainless-steel sintered body impregnated with silicone-based resin or polyester-based resin, and the use of such a friction member as a contact body. In Japanese Patent Application Laid-Open No. 2022-155688, a resin transfer film that is formed on a slide surface prevents direct contact of an elastic body with a contact body, so that there is an effect of reducing progression of “adaptation” of the elastic body and the contact body.

A friction member suitable for a contact body of a vibration-type actuator that needs high friction driving force even under higher humidity environment is desired to be developed. That is, development of a friction member in which a decrease in friction force is reduced even under higher humidity environment is desired.

### SUMMARY

The present disclosure is directed to a friction member in which a decrease in friction force under high humidity environment is reduced and that can be used as a contact body of a vibration-type actuator.

According to an aspect of the present disclosure, a friction member includes a stainless-steel-based sintered body having a pore, and a resin material that is present in at least one portion of an inside of the pore, wherein the resin material is a silicone-based resin material, and has a maximum absorption peak intensity ratio Ia/Ib of 0.10 or more in a spectrum acquired based on an infrared spectroscopic analysis, where Ia is a maximum absorption peak intensity caused by stretching vibration of Si—H bond in a range of 2079 cm⁻¹ to 2415 cm⁻¹, and Ib is a maximum absorption peak intensity caused by stretching vibration of Si—O—Si bond in a range of 1000 cm⁻¹ to 1070 cm⁻¹.

Further features of the present disclosure will become apparent from the following description of exemplary embodiments with reference to the attached drawings.

### BRIEF DESCRIPTION OF THE DRAWINGS

FIG. 1 is a schematic diagram illustrating a surface of a friction member according to a first exemplary embodiment.

FIG. 2 is a schematic diagram illustrating a friction abrasion testing machine used in an example according to the present exemplary embodiment and a comparative example.

FIG. 3 is a schematic diagram illustrating a friction force evaluation device used in the example according to the present exemplary embodiment and the comparative example.

FIGS. 4A through 4D are diagrams illustrating a driving principle of a linear drive vibration-type-actuator according to the first exemplary embodiment.

FIG. 5 is a diagram illustrating an infrared (IR) spectrum in an example 1.

FIG. 6 is a schematic diagram illustrating a configuration of an image capturing device according to a second exemplary embodiment.

FIG. 7 is a schematic diagram illustrating a configuration of a robot according to a third exemplary embodiment.

### DESCRIPTION OF THE EMBODIMENTS

A friction member discussed in the present disclosure includes a stainless-steel-based sintered body having a pore, and a resin material is present in at least one portion inside the pore. The resin material impregnated into the pore is a silicone-based resin material.

### Friction Member and Method for Manufacturing Friction Member

A friction member and a method for manufacturing the friction member according to a first exemplary embodiment are to be described in detail with reference to the drawings.

A stainless-steel-based sintered body that serves as a base of the friction member is to be described. Hereinafter, the stainless-steel-based sintered body may also be referred to as a sintered body. In the present exemplary embodiment, the stainless-steel-based sintered body contains stainless steel and has a pore.

In the description below, for example, carbon (C) and chromium (Cr) are not limited to simple substances, and atoms contained in a material such as an alloyed material are also included. For example, if a weight ratio of chromium is 10.5 wt %, such expression indicates that a chromium atom is contained at a weight ratio of 10.5 wt % regardless of a bonding state of chromium.

From a standpoint of enhancement of resistance against abrasion of the friction member, mixed powder that is a mixture of stainless-steel raw material powder and carbon raw material powder can be used as raw materials of the stainless-steel-based sintered body. However, in a case where an excess amount of carbon powder is mixed with a raw material of the sintered body, a friction force may be reduced due to a lubricating action brought by free carbon powder. Thus, a proportion of carbon powder in raw materials has an upper limit that is set to 2.0 wt %. A very small amount of carbon powder is desirably contained in raw materials of a sintered body such that the sintered body has a martensite phase.

A mold having a desired shape based on a use application is prepared, and the mold is filled with raw material powder. Then, pressure is applied to fabricate a molded member. The resultant molded member is baked at a predetermined temperature for a predetermined time. Subsequently, the molded member is cooled, so that a sintered body is fabricated. From a standpoint of abrasion resistance enhancement, carbon maybe mixed. In such a case, because formation of a martensite phase provides higher abrasion resistance, rapid cooling is desirably performed after the baking.

The sintered body in the present exemplary embodiment is stainless steel having a martensite phase and an austenite phase. In the sintered body in the present exemplary embodiment, a volume ratio of the martensite phase to a sum of volumes of the martensite phase and the austenite phase is desirably 45% or more. In a case where rapid cooling is difficult, heat treating is separately performed, or a treatment such as a subzero cryogenic treatment, a carburizing treatment, and a nitriding treatment is added as post-processing, so that higher abrasion resistance can be provided. The subzero cryogenic treatment is desirably performed after the molded member is baked, and thus a sintered body having more martensite phases can be acquired. Desirably, the subzero cryogenic treatment is a last process in manufacturing of the sintered body.

The sintered body in the present embodiment preferably contains 10.5 wt % or more of chromium from a corrosion resistance standpoint. The sintered body in the present exemplary embodiment preferably contains 0 wt % or more and 2.0 wt % or less of carbon from a standpoint of enhancement of resistance against abrasion of the friction member.

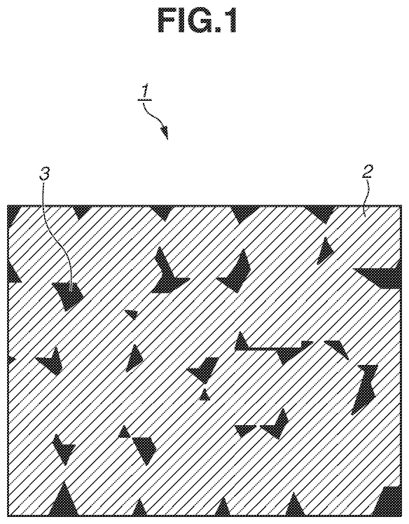

FIG. 1 is a diagram illustrating a surface of a friction member 1 according to the first exemplary embodiment. The friction member 1 has gaps that are generated when stainless-steel raw material particles 2 are bonded. Such gaps remain as pores 3 in the friction member 1. In an impregnation process to be described below, at least one portion inside the pore 3 is impregnated with resin. An area ratio of pores exposed to a friction member surface to the friction member surface is set to a surface porosity rate. Because the surface porosity rate is influenced by an area of impregnating resin exposed to the surface, the surface porosity rate is desirably controlled to fall within a predetermined range. A surface porosity rate is desirably 1.0% or higher to acquire an effect of maintaining a friction force. The surface porosity rate is desirably 20% or less from standpoints of strength and abrasion resistance of the base.

Examples of factors that control a surface porosity rate of the sintered body include a particle diameter of raw material powder, a pressure at the time of molding, a sintering temperature, and a sintering time. Because the porosity rate markedly depends on a type of material and a shape to be formed, an appropriate baking condition needs to be experimentally determined.

As for the surface porosity rate, an observation image of the surface is acquired, and an area ratio of pores in the surface is quantified using image processing software. Thus, the surface porosity rate can be measured. Alternatively, it is conceivable that a method for converting a volume and a weight that are acquired based on a measured size into a porosity rate, or a measurement method using Archimedes method can be employed. However, accurate measurement may be difficult by such alternative methods in a case where a measurement target has a complicated shape. Desirably, a porosity rate of a surface is directly measured because a density difference between the inside and the surface may be generated at the time of molding depending on a shape to be formed, or a state of a pore that is open to the surface may be changed if the surface is polished in post-processing.

A description is to be given of a resin material to be impregnated into the inside of a pore of a sintered body. The resin material to be impregnated into the inside of a pore is a silicone-based resin material, and a material having relatively many silicon-hydrogen (Si—H) bonds is used. The silicone-based resin material is a resin material having a siloxane backbone (a silicon-oxygen-silicon (Si—O—Si) backbone). The silicone-based resin material can have one or more of a substituent such as an alkyl group in a side chain of the siloxane backbone and a substituent in which an alkyl group is partially substituted. The silicone-based resin material poured into the pore of the friction member can have a structure in which a siloxane backbone is cross-linked.

In the present exemplary embodiment, the resin material desirably has a maximum absorption peak intensity ratio Ia/Ib of 0.10 or more in Fourier transform infrared (FT-IR) spectrum acquired based on an analysis of the resin material of the present exemplary embodiment by infrared spectroscopy. A maximum absorption peak intensity caused by stretching vibration of Si—H bond in a range of 2079 cm⁻¹ to 2415 cm⁻¹ is set to a maximum absorption peak intensity Ia. A maximum absorption peak intensity caused by stretching vibration of Si—O—Si bond in a range of 1000 cm⁻¹ to 1070 cm⁻¹ is set to a maximum absorption peak intensity Ib. The maximum absorption peak intensity ratio Ia/Ib is desirably 0.50 or less by the reason to be described below. For acquisition of absorption spectrum in evaluation of impregnating resin, a nano-infrared spectroscopic analyzer manufactured by Photothermal Spectroscopy Corp. can be used. For acquisition of absorption spectrum, for example, a resolution, the number of times of integration, and a measurement range are respectively set to 4 cm^{-1, 16} times, and 650 cm⁻¹ to 2500 cm⁻¹, so that impregnating resin can be analyzed.

An impregnation process and a curing process can be performed as a process for introducing a resin material to the inside of a pore of a sintered body. The impregnation process impregnates the inside of the pore with the resin material, and the curing process cures the resin material by performing a treatment such as a heating treatment on the sintered body impregnated with the resin material. The resin material may be introduced to the inside of the sintered body by only the impregnation process without the curing process.

For efficient progress of impregnation, a resin material, the components of which

are adjusted such that the resin material has a low viscosity at room temperature, is desirably used as an impregnating material. A treatment such as heat curing is performed after the impregnation, so that the resin material remains as a solid inside the pore of the sintered body. An amount of Si—H bonds to be detected from the resin material based on an infrared spectroscopic analysis that is performed after the curing is also influenced by a post-impregnation curing condition. Thus, because a curing condition suitable for a component of the resin material to be used in impregnation needs to be selected, or a component of the resin material needs to be adjusted for a curing condition, a relation between the curing condition and the component of the resin material can be experimentally studied in advance. Such a study is effective.

The resin material to be used in impregnation can be impregnated into a sintered base by general vacuum impregnation process. One or a plurality of sintered bodies is placed in a vacuum chamber, and the vacuum chamber is vacuumed to atmospheric pressure or less. The air or absorbed moisture in the pore of the sintered body is removed by the vacuuming effect, and then the resin material as an impregnating material is input inside the chamber. Pressure is applied to cause the chamber to have atmospheric pressure or higher so that the resin material is impregnated into the further inside of the pore of the sintered body. Then, the chamber is opened, and the resin is cured after the resin on a surface of the sintered body is removed by centrifugation or is wiped off.

Examples of the technique for curing the resin material include heat curing and photo curing. Preferably, the heat curing is selected from an efficiency standpoint or a standpoint of control of an amount of Si—H bonds mentioned above. If the heat curing is performed, a sintered body can be input in an oven that is controlled at a predetermined temperature, or a sintered body can be immersed in hot water. Accordingly, the use of the vacuum chamber enables resin to be impregnated further into the inside of the sintered body. The impregnation technique is not limited to the aforementioned technique. For example, a technique using gravity or a capillary phenomenon may be employed. In such a case, an appropriate amount of an impregnating resin material is applied to a friction surface, and gravity or a capillary phenomenon is used to impregnate the friction surface with the impregnating resin material.

An aftertreatment such as polishing is performed on the friction surface based on a given use application of the friction member. The friction surface of the friction member has an area excluding pores, and such an area desirably has an arithmetic mean roughness of 0 μm or more and 0.2 μm or less. If a use application, for example, a contact body of a vibration-type actuator, is expected to have higher braking performance, a friction surface is polished because a surface roughness needs to be reduced. Examples of the polishing technique include polishing with fixed abrasive grains, polishing with free abrasive grains, and barrel polishing. However, in a case where a polishing abrasive grain is excessively large, a polishing mark of large cycle is formed on the surface. Such a mark may deform a pore generated by sintering. Consequently, an excess size of abrasive grain is not desirable.

If a surface roughness does not need to be reduced based on a use application, an aftertreatment is not always necessary. In a case where a shape that is acquired after sintering markedly differs from a shape of a part, the acquired shape needs to be processed. For example, the acquired shape needs to be machined to be in the necessary shape for the part. In a case where a friction surface needs to be scraped off, the presence of resin that remains after the friction surface is processed needs to be checked. In a case where an etching rate of the friction surface by the processing exceeds a depth of resin material impregnated into the friction surface, the resin is no longer present on the friction surface. Thus, such a case is not desirable. Accordingly, resin impregnation is executed subsequent to machine work, and then finishing work such as polishing is performed as necessary, thereby acquiring a friction member having pores that are partially impregnated with resin.

A depth of resin material impregnation is desirably checked in advance because such a depth draws influence from a pore rate and a pore size of the sintered body, viscosity of an impregnating material, and an impregnation condition.

A description is to be given of how such a friction member acts for control of friction force reduction in high humidity environment. The impregnation of pores in the sintered body with resin has an effect of controlling “adaptation” of an elastic body and a contact body by the presence of a transfer film, and has an effect of reducing friction force reduction due absorption of water by an effect of water repellency of silicone resin.

The inventors have found that selection of a material containing many Si—H bonds among silicone resin materials can provide a further effect based on a result of the impregnating-resin study. It is assumed that such finding results from the presence of Si—H bond that further enhances a hydrophobic effect. It is assumed that because a difference in electronegativity causes a hydrogen atom of the Si—H bond to be strongly attracted to a silicon atom, the resin material having many Si—H bonds has large surface-free-energy, and water is repelled more easily. However, if an amount of Si—H bonds is excessive, motility of siloxane backbone is increased, and fluidity of the silicone resin is increased. Such a situation may hinder the silicone resin from staying inside the pore. Accordingly, the aforementioned maximum absorption peak intensity ratio Ia/Ib is preferably 0.50 or less. The resin inside the pore exposed to the friction surface can be analyzed by an infrared spectroscopic analyzer.

### Vibration-Type Actuator

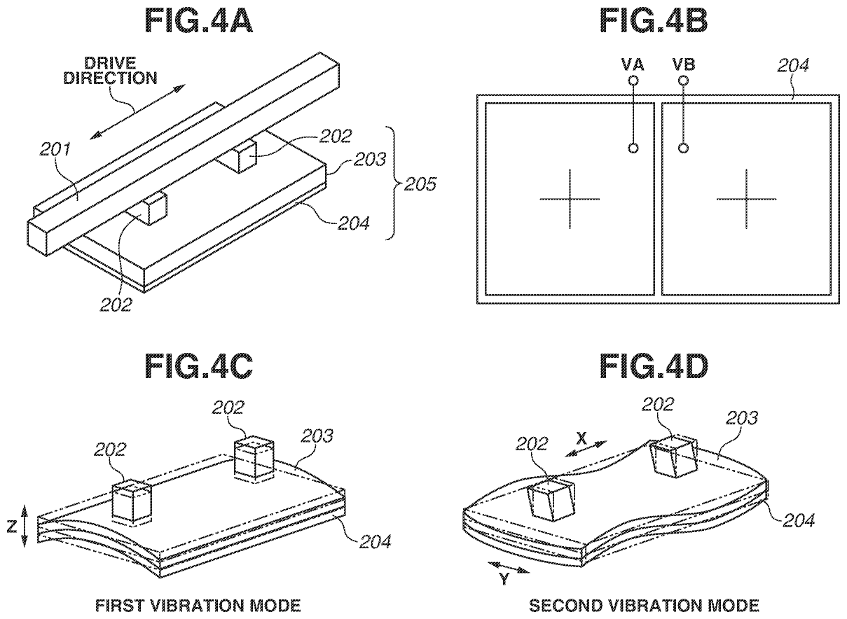

FIGS. 4A through 4D are diagrams illustrating a driving principle of a linear-driven vibration-type-motor as one example of a vibration-type actuator. The vibration-type motor illustrated in FIG. 4A includes a vibration body 205 in which a piezoelectric element 204 is attached to an elastic body 203, and a contact body 201 that is driven by the vibration body 205. Application of alternating current voltage to the piezoelectric element 204 generates two vibration modes as illustrated in FIGS. 4C and 4D, so that the contact body 201 in pressure-contact with a projection portion 202 is moved in a direction indicated by an arrow. FIG. 4B illustrates an electrode pattern of the piezoelectric element 204. For example, the piezoelectric element 204 of the vibration body 205 has an electrode area that is halved in a longitudinal direction. A polarization direction in each of the electrode areas is set to the same direction (+).

An alternating current voltage VB is applied to the right electrode area of the two electrode areas in the piezoelectric element 204 illustrated in FIG. 4B, whereas an alternating current voltage VA is applied to the left electrode area.

If the alternating current voltages VB and VA not only have frequencies near a resonance frequency in a first vibration mode but also have the same phase, the entire piezoelectric element 204 (the two electrode areas) expands at a certain moment and contracts at another moment. As a result, vibration in the first vibration mode illustrated in FIG. 4C occurs in the vibration body 205.

If the alternating current voltages VB and VA not only have frequencies near a resonance frequency in a second vibration mode but also have phases that are shifted by 180 degrees, the right electrode area of the piezoelectric element 204 contracts and the left electrode area of the piezoelectric element 204 expands at a certain moment. At another moment, such a relation is reversed. As a result, vibration in the second vibration mode illustrated in FIG. 4D occurs in the vibration body 205. Accordingly, the two vibration modes are synthesized, so that the contact body 201 is driven in a direction indicated by an arrow illustrated in FIG. 4A. An occurrence ratio of the first vibration mode to the second vibration mode can be changed by changing a phase difference of the alternating current voltages to be input to the halved electrodes. In this vibration-type motor, a change in the occurrence ratio can change a speed of a moving element.

The present exemplary embodiment has been described using an example of a two-phase-drive control apparatus that drives a piezoelectric element as an electro-mechanical energy conversion element by using two separate phases. However, the present exemplary embodiment is not limited to the two-phase-drive. The present exemplary embodiment can be applied to a vibration-type motor having two or more phases.

### Applications of Vibration-Type Actuator

Each of an image capturing device and an industrial robot is to be described as one example of a device or apparatus to which the above-described vibration-type actuator is applied.

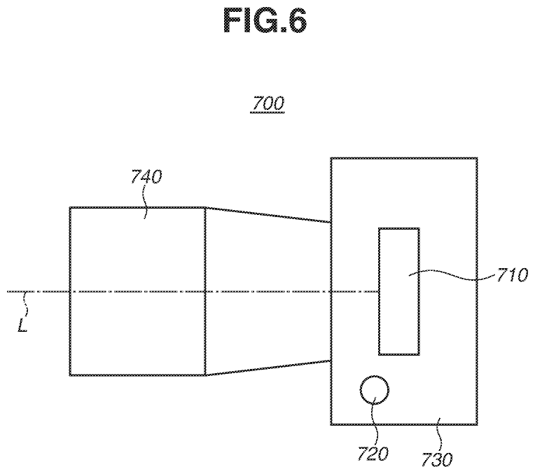

A second exemplary embodiment is to be described. FIG. 6 is a top view schematically illustrating a configuration of an image capturing device 700 as one example of an optical device. The image capturing device 700 includes a camera body 730 in which an image capturing element 710 and a power supply button 720 are arranged. The image capturing device 700 includes a lens group (not illustrated), and a lens barrel 740 including a vibration-type actuator. The vibration-type actuator drives the lens group as one example of an optical element. The lens barrel 740 can be changed an interchangeable lens. The lens barrel 740 suitable for a subject to be captured can be attached to the camera body 730. The above-described vibration-type actuator can be used as the vibration-type actuator disposed in the lens barrel 740.

Although it is conceivable that a configuration for driving a lens by a vibration-type actuator is suitable for driving of an auto-focus lens, but the usage is not limited to the auto-focus lens. It is conceivable that a zoom lens can also be driven by a similar configuration. The vibration-type actuator can be used for driving of an image capturing element, and driving of a lens or an image capturing element at the time of camera shake correction.

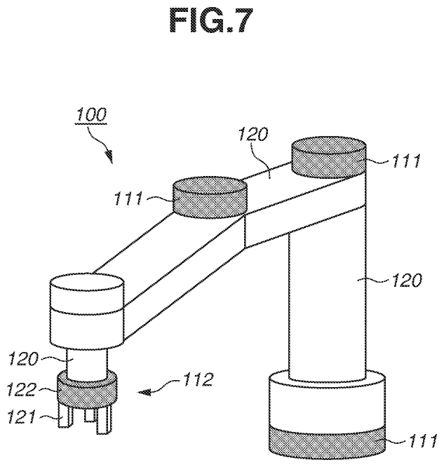

A third exemplary embodiment is to be described. FIG. 7 is a perspective view schematically illustrating a configuration of a robot 100 as one example of an electronic device in which the above-described vibration-type actuator is disposed. The robot 100 illustrated in FIG. 7 is a horizontal articulated robot as a kind of an industrial robot.

The robot 100 include an arm joint 111 and a hand unit 112. The arm joint 111 connects two arms 120 such that an angle at which the two arms 120 intersect with each other can be changed. The hand unit 112 includes the arm 120, a gripper 121 attached to one end of the arm 120, and a hand joint 122 that connects the arm 120 to the gripper 121. The vibration-type actuators are installed inside the arm joint 111 and the gripper 121 to adjust angles of the arm 120 and the hand joint 122 and to rotate the arm 120 and the hand joint 122. For an operation for bending the arm joint 111 and a gripping operation by the hand unit 112, a vibration-type actuator having a TN characteristic (a drooping characteristic indicating a relation between a load torque and a rotation speed) with which a high torque is provided at a low rotation speed is suitably used.

Although the present disclosure has been described with reference to the exemplary embodiments, the present disclosure is not limited to the specific exemplary embodiments. Note that various modifications without departing from the scope of the disclosure is included in the present disclosure. For example, an XY stage can be considered as a device that can drive a flat-plate-shaped contact body in an optional direction within a plan thereof. Each of the above-described exemplary embodiments can be executed alone or in combination.

Examples and comparative examples are to be described. As for raw materials of a sintered body, mixed powder in which a predetermined amount of carbon powder was mixed with steel use stainless (SUS) 410 powder was used. The SUS 410 powder was a Japanese Industrial Standards (JIS) product (containing 0.15 wt % or less of carbon, 11.5 wt % to 13.0 wt % of chromium, 0.5 wt % or less of silicon, 1 wt % or less of manganese (Mn), 0.04 wt % or less of phosphorus (P), 0.03 wt % or less of sulfur (S), and the remaining wt % of iron (Fe)). The raw material powder was input in a cemented carbide mold with a cavity (a hollow for molding) having a size 40 mm×5 mm, and the input raw material powder was compression-molded until a predetermined plate thickness was obtained. A weight of raw materials which were input, and a plate thickness obtained after molding in each of the examples and comparative examples are illustrated in Table 1. The resultant molded member was baked for 30 minutes at a temperature between 1050 to 1150 degrees Celsius. Then, the baked member was rapidly cooled, so that a sintered body was fabricated. Subsequently, a subzero cryogenic treatment was performed on the sintered body for 30 minutes at minus 12 degrees Celsius to further enhance hardness of the sintered body.

A density of the sintered body is also illustrated in Table 1. The density illustrated in Table 1 was measured using Archimedes method after the subzero cryogenic treatment was performed.

A martensite phase rate was measured using a magnetodielectric method by FISCHERSCOPE manufactured by Fischer Instruments. However, because the measurement value acquired by such a method indicated a volume ratio of a martensite phase component in a total volume including pores, the measurement value needed to be converted into a martensite phase rate based on a volume excluding a total pore rate calculated from a theoretical density and a bulk density. For example, if a measurement value acquired using the magnetodielectric method is 40% and a total pore rate of a sintered body is 10%, a martensite phase rate is determined based on 90% that excludes the pores, that is, a martensite phase rate to be determined is 40/90=44.4%. Based on the density illustrated in Table 1, a martensite phase rate in a material excluding pores as described above was determined. Every sintered body had a high martensite phase rate that was between 47% to 50%. An amount of carbon contained in some of sintered bodys out of the fabricated sintered bodys were analyzed without post-processing. The rates of carbon analyzed using a combustion-infrared absorption method were between 0.2 wt % to 1.2 wt %.

Next, resin impregnation is to be described. An impregnating resin material containing adjusted components was impregnated into a sintered body. The sintered body was input in a vacuum chamber in a state in which the sintered body was placed in a metal mesh cage, and a cover of the chamber was closed. A pressure inside the chamber was decreased to 1 kPa or less. Then, an impregnating material was input through piping connected to the chamber. An amount of the impregnating material input was sufficient for the metal mesh cage to be immersed. Subsequently, a pressure was applied to the chamber, and the chamber was left for 10 minutes when a pressure was increased to 0.5 MPa. The pressure in the chamber was released, and the sintered body was removed from the chamber. A residue on a surface of the sintered body was removed by centrifugation. Subsequently, the resultant sintered body was left for one hour in an oven having a temperature of 100 degrees Celsius, so that the resin impregnated into the sintered body was hardened.

After completion of the impregnation, a surface opposite a friction surface was ground to arrange a plate thickness to 1.5 mm. After the plate thickness arrangement, finish polishing was performed on the friction surface. The friction surface was polished for three minutes by using silicon carbide (SiC) abrasive polishing paper of #1200, and then was lap-polished for 15 minutes by using 3-μm diamond abrasive grains as polishing processes. In both of the polishing processes, a load per sintered body was set to 1000 g. As for a roughness of the surface on which the polishing had been performed, an area without a pore was selected, and an arithmetic mean roughness Ra in a distance of 0.7 mm was measured by a scanning-type white light interference microscope manufactured by Hitachi High-Tech Science Corporation. The measurements were made at 10 locations within the friction surface, and a mean value was determined. As a result, each of the arithmetic mean roughness Ra was 0.03 or less.

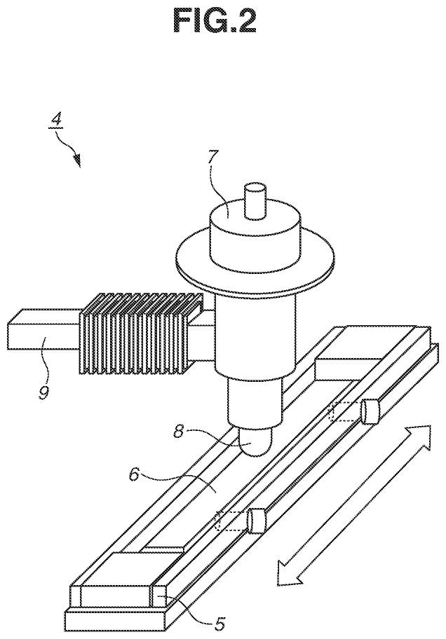

A friction force of the fabricated friction member was evaluated. In addition, a surface porosity rate was evaluated, and impregnating resin was analyzed. The friction force was evaluated after pre-sliding was performed so that an influence of humidity was distinguished more easily. FIG. 2 is a schematic diagram illustrating a friction abrasion testing machine used in the pre-sliding. A friction member 6 was placed in a state in which the friction member 6 was fixed to a movable stage 5 with a screw, and a pin member 8 and the friction member 6 were brought into contact with each other in a state in which a load was applied by a weight 7. Then, friction sliding was performed by reciprocally driving the stage 5 for 10,000 times at a moving speed of 25 mm/s in a range of 30 mm.

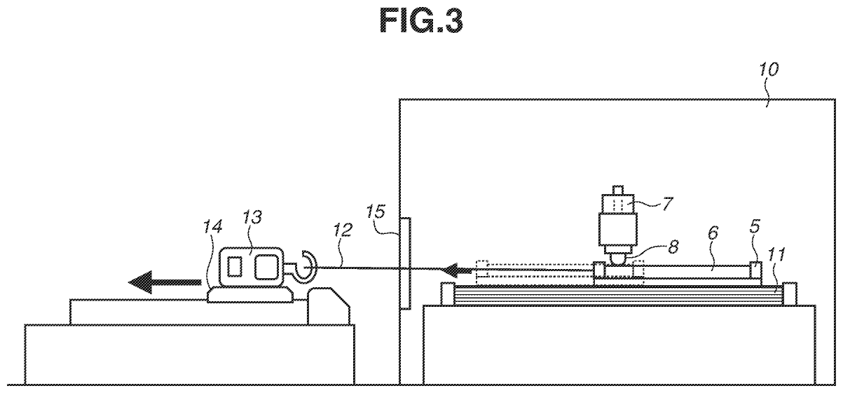

The friction force was evaluated under high-temperature and high-humidity environment by using a friction force evaluation device illustrated in FIG. 3.

The friction member 6 was fixed to a slide rail 11 placed inside a thermo-hygrostat chamber 10 in a state in which friction member 6 was fixed to the stage 5. The slide rail 11 was a ball-slide-type slide rail to prevent generation of sliding resistance. The pin member 8 which had been used in the pre-sliding was used as it was. The pin member 8 was fixed by an arm in the same way as the friction abrasion test, and was brought into contact with the friction member 6 in a state in which a load of the weight 7 of 150 grams was applied. A contact position between the pin member 8 and the friction member 6 was adjusted to a position of a sliding end in which the pre-sliding had been performed.

The stage 5 was connected to a force gage 13 outside the thermo-hygrostat chamber 10 via a string 12 that had passed through a pore arranged in a leading edge of the stage 5. For the string 12, a string made of Kevlar (registered trademark) having high strength was used. The string 12 passed through an access window 15 arranged on an inner door of the thermo-hygrostat chamber 10. The access window 15 was selected because a shape of the access window 15 could provide a space to prevent the string 12 from touching a surrounding component at the time of measurement. The force gage 13 was connected to a single-axis robot 14, and driving of the single-axis robot 14 pulled the stage 5, thereby enabling a friction resistance acting between the pin member 8 and the friction member 6 to be measured by the force gage 13. The slide rail 11 and the single-axis robot 14 were coaxially arranged, and positions of the stage 5 and the force gage 13 were individually adjusted to match heights such that an error due to a pulling angle was not generated.

The thermo-hygrostat chamber 10 was operated. After a temperature and a humidity inside the thermo-hygrostat chamber 10 reached 40 degrees Celsius and 90%, respectively, the thermo-hygrostat chamber 10 was left for 6 hours, and a friction force of the friction member was measured. A pulling speed and a pulling distance were set to 1 mm/s and 30 mm, respectively, and a mean value of friction forces in positions from a position 2 mm away from a starting position in which a measurement value was relatively stabilized to a position 28 mm away from the starting position. Friction coefficients determined based on the mean value are illustrated in Table 1. A surface porosity rate was determined as follows. An image of the friction surface was captured at a magnification of 200 times by an optical microscope, the resultant image data was binarized to calculate an area having a pore, and a surface porosity rate was determined based on the calculated area. A mean value of the surface porosity rates at 10 locations within the friction surface is illustrated in Table 1.

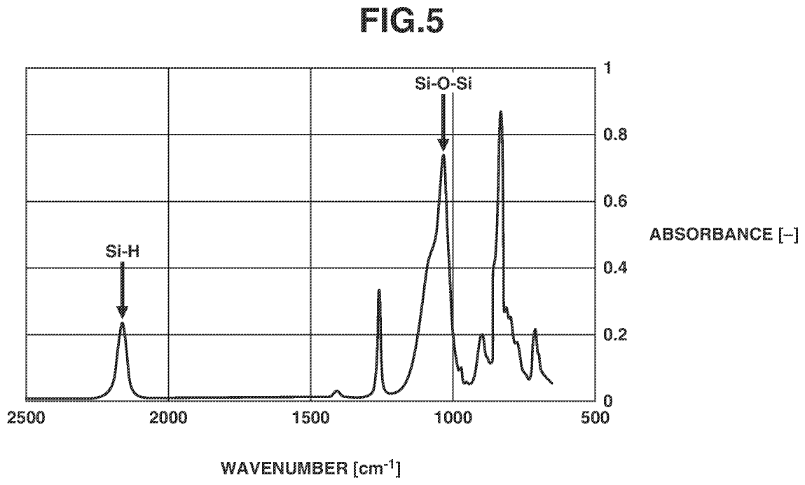

In the evaluation of impregnating resin, a nano-infrared spectroscopic analyzer manufactured by Photothermal Spectroscopy Corp., was used to evaluate resin that was present inside a pore. A resolution, the number of times of integrations, and a measurement range were set to 4 cm⁻¹, 16 times, and 650 cm⁻¹ to 2500 cm⁻¹, respectively. FIG. 5 illustrates an infrared (IR) spectrum measured in an example 1. In FIG. 5, arrows indicate a peak caused by stretching vibration of Si—H bond and a peak caused by stretching vibration of Si—O—Si bond. In the acquired spectrum, a maximum absorption peak intensity caused by the stretching vibration of Si—H bond to be detected in a range of 2079 cm⁻¹ to 2415 cm⁻¹ was set to a maximum absorption peak intensity Ia. A maximum absorption peak intensity caused by the stretching vibration of Si—O—Si bond to be detected in a range of 1000 cm⁻¹ to 1070 cm⁻¹ was set to a maximum absorption peak intensity Ib. A maximum absorption peak intensity ratio Ia/Ib was calculated. The ratio

Ia/Ib is illustrated in Table 1.

TABLE 1

| | Sintered Body | | | Impregnating | Friction Member (After Polishing) | | |
|---|---|---|---|---|---|---|---|
| | Raw | | | Material | Surface | Ratio | Friction |
| | material | Plate | Density | Resin Material | Porosity | Ia/Ib | Coefficient |
| | Weight(g) | Thickness(mm) | (g/cm³) | System | Rate (%) | (−) | (−) When Wet |
| Example 1 | 2.92 | 1.8 | 6.91 | Silicone-Based | 2.0 | 0.32 | 0.42 |
| Example 2 | 2.83 | 1.8 | 6.74 | Silicone-Based | 4.0 | 0.32 | 0.48 |
| Example 3 | 3.60 | 2.5 | 6.28 | Silicone-Based | 11.2 | 0.32 | 0.48 |
| Example 4 | 4.50 | 3.2 | 6.05 | Silicone-Based | 17.6 | 0.32 | 0.40 |
| Example 5 | 3.60 | 2.5 | 6.30 | Silicone-Based | 10.8 | 0.12 | 0.38 |
| Example 6 | 3.60 | 2.5 | 6.31 | Silicone-Based | 11.5 | 0.46 | 0.43 |
| Comparative | 3.60 | 2.5 | 6.27 | Silicone-Based | 10.8 | 0.05 | 0.31 |
| Example 1 | | | | | | | |
| Comparative | 3.60 | 2.5 | 6.31 | Silicone-Based | 11.7 | (0.55) Test | No |
| Example 2 | | | | | | Piece Was Used | Impregnation |
| Comparative | 3.60 | 2.5 | 6.29 | polyester-Based | 11.0 | NA | 0.29 |
| Example 3 | | | | | | | |

In each of the examples 1 through 6 in Table 1, a friction member impregnated with silicone-based resin having a maximum absorption peak intensity ratio Ia/Ib of 0.10 or more determined by an infrared spectroscopy had a high friction coefficient even in a state in which the friction member was left for a longer period of time under high humidity environment. On the other hand, in a comparative example 1 in Table 1, a friction member impregnated with silicone-based resin having a maximum absorption peak intensity ratio Ia/Ib of below 0.10 had a low friction coefficient. In a comparative example 2, a friction member impregnated with silicone-based resin that had been adjusted to have more Si—H bonds was fabricated. However, the resin did not remain inside a pore based on surface observation that was performed after all processes. This resin was not impregnated into a resin test piece that was fabricated by being cured under the same curing conditions. The resin test piece had a maximum absorption peak intensity ratio Ia/Ib of 0.55 based on an infrared spectroscopic analysis. In a comparative example 3 as illustrated in Table 1, a friction member impregnated with polyester-based resin had a low friction coefficient as similar to the comparative example 1. These results confirmed that fabrication of a friction member impregnated with silicone-based resin having a maximum absorption peak intensity ratio Ia/Ib of 0.10 or more could provide a higher friction force even under high-humidity environment.

The disclosure of the present exemplary embodiments includes the following methods and configurations.

### Configuration 1

A friction member includes a stainless-steel-based sintered body having a pore, and a resin material that is present in at least one portion of an inside of the pore, wherein the resin material is a silicone-based resin material, and has a maximum absorption peak intensity ratio Ia/Ib of 0.10 or more in a spectrum acquired based on an infrared spectroscopic analysis, where Ia is a maximum absorption peak intensity caused by stretching vibration of Si—H bond in a range of 2079 cm⁻¹ to 2415 cm⁻¹, and Ib is a maximum absorption peak intensity caused by stretching vibration of Si—O—Si bond in a range of 1000 cm⁻¹ to 1070 cm⁻¹.

### Configuration 2

The friction member according to the configuration 1, wherein the sintered body is stainless steel including a martensite phase and an austenite phase, and includes the martensite phase at a volume ratio of 45% or more.

### Configuration 3

The friction member according to the configuration 1 or 2, wherein the friction member has a friction surface that has an area excluding a pore, and the area has an arithmetic mean roughness of 0 μm or more and 0.20 μm or less.

### Configuration 4

The friction member according to any one of the configurations 1 through 3, wherein the sintered body has a surface porosity rate of 1.0% or more and 20% or less, the surface porosity rate being a proportion of a pore area to a surface area of the sintered body.

### Configuration 5

The friction member according to any one of the configurations 1 through 4, wherein the maximum absorption peak intensity ratio Ia/Ib acquired based on the infrared spectroscopic analysis is 0.50 or less.

### Configuration 6

The friction member according to any one of the configurations 1 through 5, wherein the sintered body contains 0 wt % or more and 2.0 wt % or less of carbon.

### Configuration 7

A vibration-type actuator that includes a vibration body including an electro-mechanical energy conversion element and an elastic body, and a contact body that pressure-contacts the vibration body, wherein the vibration-type actuator relatively moves the vibration body and the contact body by vibration excited in the vibration body, and wherein the contact body is the friction member according to any one of the configurations 1 through 6.

### Configuration 8

An optical device that includes the vibration-type actuator according to the configuration 7, and at least one of an optical element and an image capturing element that are driven by the vibration-type actuator.

### Configuration 9

An electronic device that includes a member, and the vibration-type actuator according to the configuration 7, the vibration-type actuator being configured to drive the member.

### Method 1

A friction member manufacturing method that includes fabricating a stainless-steel-based sintered body having a pore, and acquiring a friction member by impregnating the pore of the stainless-steel-based sintered body with silicone-based resin to cause an inside of the pore to have a resin material having a maximum absorption peak intensity ratio Ia/Ib of 0.10 or more in a spectrum acquired based on an infrared spectroscopic analysis, where Ia is a maximum absorption peak intensity caused by stretching vibration of Si—H bond in a range of 2079 cm⁻¹ to 2415 cm⁻¹, and Ib is a maximum absorption peak intensity caused by stretching vibration of Si—O—Si bond in a range of 1000 cm⁻¹ to 1070 cm⁻¹.

### Method 2

The friction member manufacturing method according to the method 1, wherein the fabricating of the sintered body includes acquiring mixed powder by mixing stainless-steel raw material powder with carbon raw material powder, and baking, after the mixed power is pressed in a mold, a resultant molded member by baking and rapidly cooling the molded member.

### Method 3

The friction member manufacturing method according to the method 2, wherein the fabricating of the sintered body includes subzero cryogenic treatment that is executed subsequent to the baking, and subzero cryogenic treatment is a last process.

Each of the exemplary embodiments can provide a friction member in which a decrease in friction force under high humidity environment is reduced and that can be used as a contact body of a vibration-type actuator.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Applications No. 2023-040820, filed Mar. 15, 2023, and No. 2024-001515, filed Jan. 9, 2024, which are hereby incorporated by reference herein in their entirety.

What is claimed is:

1. A friction member comprising:
a stainless-steel-based sintered body having a pore; and
a resin material that is present in at least one portion of an inside of the pore,
wherein the resin material is a silicone-based resin material, and has a maximum absorption peak intensity ratio Ia/Ib of 0.10 or more in a spectrum acquired based on an infrared spectroscopic analysis, where Ia is a maximum absorption peak intensity caused by stretching vibration of Si—H bond in a range of 2079 cm⁻¹ to 2415 cm⁻¹, and Ib is a maximum absorption peak intensity caused by stretching vibration of Si—O—Si bond in a range of 1000 cm⁻¹ to 1070 cm⁻¹.

2. The friction member according to claim 1, wherein the sintered body is stainless steel including a martensite phase and an austenite phase, and includes the martensite phase at a volume ratio of 45% or more.

3. The friction member according to claim 1, wherein the friction member has a friction surface that has an area excluding a pore, and the area has an arithmetic mean roughness of 0 μm or more and 0.20 μm or less.

4. The friction member according to claim 1, wherein the sintered body has a surface porosity rate of 1.0% or more and 20% or less, the surface porosity rate being a proportion of a pore area to a surface area of the sintered body.

5. The friction member according to claim 1, wherein the maximum absorption peak intensity ratio Ia/Ib acquired based on the infrared spectroscopic analysis is 0.50 or less.

6. The friction member according to claim 1, wherein the sintered body contains 0 wt % or more and 2.0 wt % or less of carbon.

7. A vibration-type actuator comprising:
a vibration body including an electro-mechanical energy conversion element and an elastic body; and
a contact body that pressure-contacts the vibration body,
wherein the vibration-type actuator relatively moves the vibration body and the contact body by vibration excited in the vibration body, and
wherein the contact body is the friction member according to claim 1.

8. An optical device comprising:
the vibration-type actuator according to claim 7; and
at least one of an optical element and an image capturing element that are driven by the vibration-type actuator.

9. An electronic device comprising:
a member; and
the vibration-type actuator according to claim 7, the vibration-type actuator being configured to drive the member.

10. A friction member manufacturing method comprising:
fabricating a stainless-steel-based sintered body having a pore; and
acquiring a friction member by impregnating the pore of the stainless-steel-based sintered body with silicone-based resin to cause an inside of the pore to have a resin material having a maximum absorption peak intensity ratio Ia/Ib of 0.10 or more in a spectrum acquired based on an infrared spectroscopic analysis, where Ia is a maximum absorption peak intensity caused by stretching vibration of Si—H bond in a range of 2079 cm⁻¹ to 2415 cm⁻¹, and Ib is a maximum absorption peak intensity caused by stretching vibration of Si—O—Si bond in a range of 1000 cm⁻¹ to 1070 cm⁻¹.

11. The friction member manufacturing method according to claim 10,
wherein the fabricating of the sintered body includes:
acquiring mixed powder by mixing stainless-steel raw material powder with carbon raw material powder; and
baking, after the mixed power is pressed in a mold, a resultant molded member by baking and rapidly cooling the molded member.

12. The friction member manufacturing method according to claim 11,
wherein the fabricating of the sintered body includes subzero cryogenic treatment that is executed subsequent to the baking, and
wherein the subzero cryogenic treatment is a last process.
